(19) United States
(12) Patent Application Publication
(10) Pub. No.: US 2017/0043376 A1
(43) Pub. Date: Feb. 16, 2017

(54) SLURRY SCREEN CLOTH

(71) Applicant: SYNCRUDE CANADA LTD. in trust for the owners of the Syncrude Project as such owners exist now and, Fort McMurray (CA)

(72) Inventors: YEU (JOHN) TIEU, Fort McMurray (CA); KHALED OBAIA, Edmonton (CA); DANIEL MACNEIL, Fort McMurray (CA); DAMIEN REID, Edmonton (CA)

(21) Appl. No.: 15/236,096

(22) Filed: Aug. 12, 2016

Related U.S. Application Data
(60) Provisional application No. 62/205,149, filed on Aug. 14, 2015.
(60) Provisional application No. 62/250,859, filed on Nov. 4, 2015.

(51) Int. Cl. B07B 1/46

(52) U.S. Cl. CPC B07B 1/4681; B07B 1/4618

(57) ABSTRACT

A planar screen cloth for use in a screening device for screening out oversize objects in a material flowing in a direction includes a metal plate substructure having a perimeter and a plurality of longitudinal ligaments and transverse ligaments, forming a grid. A wear-resistant layer is applied to the entire screen cloth. Each transverse ligament comprises a leading edge and a trailing edge; and is angled such that the leading edge is disposed below the trailing edge. The transverse element thus is angled to face the direction of material flow.

### FIELD OF THE INVENTION

The present invention relates generally to stationary or vibrating screening devices, and in particular, a screen cloth useful in stationary, rotating and/or vibrating screens for screening oversize objects in a material.

### BACKGROUND

Vibrating, rotating and/or stationary screens are used in the oil sand industry such as in oil sand slurry preparation plants. Oil sand mined in the Fort McMurray region of Alberta, generally comprises water-wet sand grains held together by a matrix of viscous bitumen, It lends itself to liberation of the sand grains from the bitumen by mixing or slurrying the oil sand in water, allowing the bitumen to move to the aqueous phase.

As-mined or pre-crushed oil sand is generally mixed with warm or hot water to yield an oil sand slurry. The slurry is then conditioned in a hydrotransport pipeline and subsequently introduced into a cylindrical vessel with a conical-bottom, commonly termed a primary separation vessel (PSV), where the more buoyant aerated bitumen rises to the surface and forms a bitumen froth layer.

It may be desirable to remove the larger aggregates present in oil sand slurry prior to pipelining in order to avoid blockage or damage of downstream equipment, e.g., pump component wear. Thus, vibrating, rotating and/or stationary screens are used at various points during slurry preparation to reject larger lumps of oil sand, rocks and other aggregates, which are large enough to block or damage downstream equipment, prior to pipeline conditioning. Screens may also be used to further screen oil sand tailings slurry prior to treating/disposing same.

However, oil sand slurry is heavy and abrasive due to the large amount of sand, gravel and crushed rock contained therein. Further, in particular with primary vibrating screens, these screens are generally vibrating with an acceleration of approximately 4-5 g, so that all oil sand slurried material passes over and through the screen cloths of the vibrating screen. This results in the rapid spalling and eventual wearing through of the screen cloths of the vibrating screen (“hole-throughs”), which can lead to production interruption and an unplanned maintenance event.

Various types of screen cloths are currently used. Hard-faced screen cloths such as tungsten carbide overlays provide excellent resistance against abrasion wear, but often prematurely fail due to impact and fatigue damage. Elastomer-lined screen cloths exhibit improved wear performance due to their energy-dampening capability through elastic deformation; however, when the impact energy of oversize reject material is beyond the elastic capability of the elastomers, tearing or gouging occurs. Other screen cloths comprise structural metal, with an elastomer coating or liner and having embedded hard faced wear material on the cross-members which form the screen grid. Because material flow over a screen cloth is typically directional, the leading edge was subject to the highest energy impacts and impingement. One solution, described in co-pending U.S. Patent Application Publication No. 20160038976, is to reinforce the leading edge (1) with a sintered tungsten carbide wear element (2) embedded in an elastomer (3), which encases a structure (4), as is shown in FIG. 1 (Prior Art).

### SUMMARY OF THE INVENTION

In one aspect, the invention may comprise a planar screen cloth for use in a screening device for screening out oversize objects in a material flowing in a direction, comprising:
a. a metal plate substructure having a perimeter and comprising a plurality of longitudinal ligaments and a plurality of transverse ligaments, wherein each transverse ligament comprises a leading edge and a trailing edge; and
b. a wear resistant layer applied on the substructure and comprising a top surface defining a top surface plane;
c. wherein each transverse ligament comprises an upper wear surface presented at an angle to the top surface plane, such that the leading edge is disposed below the trailing edge.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention, However, one skilled in the art will understand that portions of the example or aspect may be used in combination with other examples or aspects of the invention.

FIG. 1 is a cross-section of a prior art transverse ligament in an elastomer with structural steel reinforced screen cloth.

FIG. 2 is a top plan view of one embodiment of a screen cloth of the present invention.

FIG. 3 is a cross-sectional view along line III in FIG. 2.

FIG. 4 is a detail view of a portion of FIG. 3.

FIG. 5 is a cross-sectional view along line V in FIG. 2.

FIG. 6 is a detail view of a portion of FIG. 5.

FIG. 7 shows a cross-sectional view of an alternative embodiment.

### DETAILED DESCRIPTION

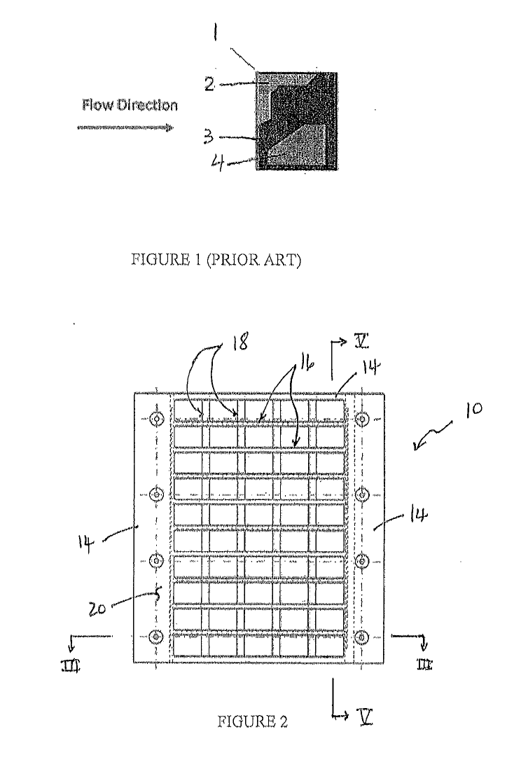

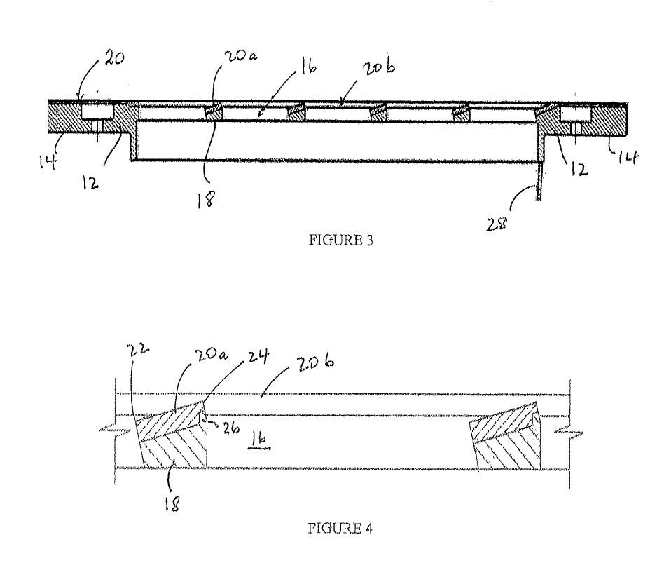

The present invention relates to a screen cloth for use in a stationary, rotating or vibrating screen. With reference now to FIGS. 2 to 7, generally, screen cloth (10) comprises a metal plate substructure (12) having a perimeter (14) and comprising a plurality of longitudinal ligaments (16) and a plurality of transverse ligaments (18), which together form a grid defining a plurality of openings. An upper layer (20) comprising a wear-resistant material is applied on the upper surface of the substructure. When installed and in use, the longitudinal ligaments are aligned with the direction of flow of material. The upper wear resistant layer (20a) on each transverse ligament (18) is presented at an angle to the planar upper surface of the screen cloth (10), such that its leading edge (22) is lower than its trailing edge (24).

As used herein, the terms “upper”, “top” or “lower” or “bottom” refer to the relative position of elements when the screen cloth is disposed horizontally as shown in FIG. 2, which may or may not be its actual orientation when installed and used. In one embodiment, the screen cloth is intended to be installed at an angle to horizontal, for example, about 14° downwards from leading edge to trailing edge.

In one embodiment, each transverse ligament is angled approximately 14° from the plane of the screen cloth, such that the top surface of the transverse ligament is horizontal if the entire screen cloth is angled downwards as described above. If the top surface is not angled, or the angle is too small, for example less than about 5°, the upper wear-resistant layer (20a) may not protect the substructure beneath the leading edge (22) from erosion. If the angle is too large, for example, greater than about 30°, the substructure below the trailing edge (24) may become exposed. As well, direct impacts to the transverse ligament in a direction perpendicular to the upper surface may result in large stresses to the structural integrity of the substructure and more wear on the transverse ligament.

In one embodiment, the entire substructure (12) is fabricated, machined or cast as a monolithic element. The upper layer (20) comprising wear-resistant material is then overlaid over the entire substructure using conventional techniques such as PTA welding or cladding. In one embodiment, a buttering technique using a thin layer of a material such as nickel or copper intermediate the substructure and the wear-resistant layer may prevent spalling which could result from the formation of a brittle iron carbide layer. In alternative embodiments, the wear-resistant layer may be brazed, glued or mechanically fastened to the substructure.

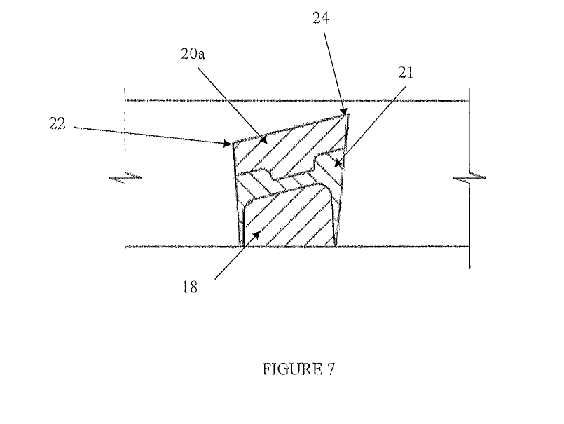

In an alternative embodiment, as shown in FIG. 7, an elastomer layer (21) may be disposed between the substructure (12) and the upper wear-resistant layer (20a), in which case, the wear-resistant layer may be vulcanized to the elastomer layer (21). As used herein, the term “elastomer” means a material which exhibits the property of elasticity, namely the ability to deform when a stress is applied and to recover its original form (i.e., length, volume, shape, etc.) spontaneously when the stress is removed. Elastomers typically have a low Young's modulus (i.e., the ratio of stress to strain, expressed in units of pressure), and a high yield strain (i.e., the strain at which a material begins to deform plastically). Suitable elastomers include, but are not limited to, rubber, polyurethane, other thermosetting elastomers, and thermoplastic elastomers.

The substructure (12) can be entirely coated with elastomer (21) on both the impact surface and the bottom surface. It is understood, however, that in some embodiments of the present invention, only the impact surface is coated or lined with elastomer. The elastomer may provide some benefit by dampening the energy of impacts from larger pieces of debris.

As used herein, a “wear-resistant material” is any material known to have greater abrasion resistance than the underlying substrate. Such material may include, without limitation, metallic materials, industrial diamond, ceramic or non-ceramic carbides such as chromium carbide, tungsten carbide, or a cermet such as sintered tungsten carbide. Sintered tungsten carbide, also known as cemented carbide, is a composite material comprising tungsten carbide powder mixed with a binder metal such as cobalt or nickel, compacted in a die and then sintered at a very high temperature and pressure. Wear-resistant materials may also include various ceramic materials such as alumina or a nitride such as silicon nitride. As used herein, a ceramic material is an inorganic, non-metallic, oxide, nitride or carbide material, which may or may not be crystalline. Suitable wear-resistant materials are well known in the art and are readily commercially available.

The trailing edge of the transverse ligament substructure may comprise a small lip (26) which extends the length of the transverse ligament (18). This lip (26) facilitates the PTA welding process of overlaying the wear-resistant material. As well, the lip (26) provides additional strength to resist shear forces which would tend to separate the wear-resistant layer (20) from the substructure (12).

In one embodiment, a skirt (28) or baffle plate extends downwardly from the trailing edge perimeter of the substructure, parallel to the transverse ligaments such that it faces the flow of the drained slurry. The skirt (28) protects the cross beam (not shown) of elements behind it from wear from impact and abrasion by the drained slurry.

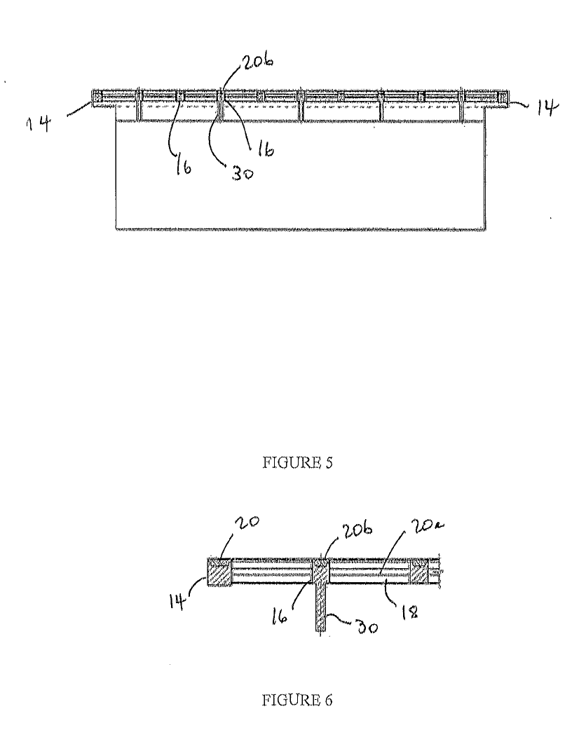

As seen in FIG. 5, each longitudinal ligament (16) comprises a substructural element overlaid with the wear-resistant layer (20b). In one embodiment, some or all of the longitudinal ligaments (16) comprises a stiffener (30) which adds bending stiffness to the entire screen cloth (10). The stiffener (30) may be formed integrally with the longitudinal ligament (16) or may be a welded attachment.

In one embodiment, each transverse ligament (18) is recessed below the level of the longitudinal ligaments (16), such that the top of the trailing edge (24) is about 10 mm, for example, below the upper surface of the longitudinal ligaments. As a result, the transverse ligaments may be shielded from impacts by rocks which are significantly larger than the distance between two adjacent longitudinal ligaments (16). Smaller materials are then “channeled” between the longitudinal ligaments as the material flows over the screen cloth (10).

### Definitions and Interpretation

The singular forms “a,” “an,” and “the” include plural reference unless the context clearly dictates otherwise. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention,

The term “and/or” means any one of the items, any combination of the items, or all of the items with which this term is associated, The phrase “one or more” is readily understood by one of skill in the art, particularly when read in context of its usage,

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range of values includes each specific value, integer, decimal, or identity within the range, Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

As will be apparent to those skilled in the art, various modifications, adaptations and variations of the foregoing specific disclosure can be made without departing from the scope of the invention claimed herein. The various features and elements of the invention described herein may be combined in a manner different than the specific examples described or claimed herein without departing from the scope of the invention. In other words, any element or feature may be combined with any other element or feature in different embodiments, unless there is an obvious or inherent incompatibility between the two, or it is specifically excluded.

What is claimed is:

1. A planar screen cloth for use in a screening device for screening out oversize objects in a material flowing in a direction, comprising:
a. a metal plate substructure having a perimeter and comprising a plurality of longitudinal ligaments and a plurality of transverse ligaments, wherein each transverse ligament comprises a leading edge and a trailing edge; and
b. a wear resistant layer overlaid on the substructure and comprising a top surface defining a top surface plane;
c. wherein each transverse ligament comprises an upper wear surface presented at an angle to the top surface plane, such that the leading edge is disposed below the trailing edge.

2. The screen cloth of claim 1 wherein the angle of the transverse ligament is between about 5° and 30°.

3. The screen cloth of claim 2 wherein the angle is about 14°.

4. The screen cloth of claim 1, wherein the top surface of each transverse ligament is recessed below the top surface of each longitudinal ligament.

5. The screen cloth of claim 1 wherein the substructure is fabricated, machined or cast as a monolithic element.

6. The screen cloth of claim 3 wherein each transverse ligament substructure comprises a raised lip extending the length of the transverse ligament edge which supports the wear-resistant layer.

7. The screen cloth of any previous claim wherein the wear-resistant layer is applied by plasma arc transfer welding, with or without a buttering layer.

8. The screen cloth of claim 1, wherein the wear-resistant layer is applied by brazing, gluing or vulcanizing.

9. The screen cloth of claim 1 further comprising a skirt which depends downwardly from the substructure, substantially parallel to the transverse ligaments.

10. The screen cloth of claim 1 wherein some or all of the longitudinal elements comprises a stiffener for stiffening the screen cloth.

11. The screen cloth of claim 1 wherein the wear resistant layer comprises tungsten carbide.

12. The screen cloth of claim 1 further comprising an elastomer layer disposed between the metal plate substructure and the wear resistant layer.
